(19) United States
(12) Patent Application Publication
(10) Pub. No.: US 2022/0269734 A1
(43) Pub. Date: Aug. 25, 2022

(54) INTELLIGENT NATURAL LANGUAGE DIALOGUE SYSTEMS AND METHODS FOR CREATING INTELLIGENT NATURAL LANGUAGE DIALOGUES FOR EFFICIENT RETRIEVAL OF ITEMS IN ONE OR MORE LARGE DATABASES

(71) Applicant: ZEBRA TECHNOLOGIES CORPORATION, Lincolnshire, IL (US)

(72) Inventor: Dale W. Russell, Palatine, IL (US)

(21) Appl. No.: 17/179,983

(22) Filed: Feb. 19, 2021

(51) Int. Cl. G06F 16/9032; G06F 16/904; G06F 16/9035; G10L 15/06; G10L 15/197; G10L 15/18

(52) U.S. Cl. CPC G06F 16/90332; G06F 16/904; G06F 16/9035; G10L 15/063; G10L 15/197; G10L 15/1815; G10L 2015/0638

(57) ABSTRACT

Intelligent natural language dialogue systems and methods are described for creating intelligent natural language dialogues for efficient retrieval of items in one or more large databases. An intelligent dialogue model is trained with feature-value pair(s) corresponding to natural language phrase(s) defining respective feature-specific intents. The intelligent dialogue model interprets the audible utterance of a user to determine user-specific feature-value pair(s), where the audible utterance comprises a natural language phrase corresponding to a feature-specific intent. An item is identified based on a matching score determined from the user-specific feature-value pair(s) compared with one or more item definitions defined in a database.

### BACKGROUND

Typically, for search purposes, a person seeks to identify an item, or related information, from a large multi-featured database. Examples include an automobile, identified by make, year, model and style; or media for a printer, identified by media type, material, dimensions, perforation and color.

With existing computer-implemented search tools, including those that implement voice recognition or voice input, a person must answer a sequence of questions in an order predetermined by the system. Some of these questions may be unnecessary, however, as they do not aid in identifying a desired item. For others, the person may not know the answer, and cannot proceed. In other cases, an answer may be arrived at, but more questions are asked than is necessary, which is inefficient.

Accordingly, there is a need for creating intelligent natural language dialogue systems and methods for efficient retrieval of items in one or more large databases to alleviate such issues.

### SUMMARY

Through the use of intelligent natural language dialogue systems and methods described here, a user can provide, via voice, the information the user is knowledgeable about, and be guided, by the intelligent natural language dialogue systems and methods, in providing additional information needed to arrive at a desired result, e.g., an output from a given system regarding desired information.

Generally, the intelligent natural language dialogue systems and methods described herein operate by learning an one or more feature-specific intents (also referred to herein as “intents” or “intent”) taken from a user's voice input, and then uses those feature-specific intents to implement fulfillment, e.g., providing or identifying an item within a database, e.g., a large database system. A feature-specific intent delineates a single exchange between a user and a computational system, proscribing what the user may say, how their language is interpreted, and how the system acts in response, both in its response back to the user and other actions that it should take as a result. These other actions are determined by fulfillment, which is embodied in a computer program, as described herein.

In some embodiments, there may be a single feature-specific intent for initiating a voice query, in which a user may offer any audible information, in any combination, to identify an item from a given database. Additionally, or alternatively, one specialized feature-specific may exist for each feature in the database (e.g., a one-to-one intent-to-feature relationship), which may be used to capture a user's response to system requests (e.g., prompts) for information regarding the feature-specific intent and/or the feature.

In an embodiment, the present invention is an intelligent natural language dialogue system configured to create intelligent natural language dialogues for efficient retrieval of items in one or more large databases. The intelligent natural language dialogue system comprises: a computing device comprising one or more processors and an intelligent dialogue model accessible by the one or more processors. The intelligent dialogue model is trained with one or more of feature-value pairs corresponding to one or more natural language phrases defining respective feature-specific intents. The intelligent natural language dialogue system further comprises a voice assistant application (app) comprising computing instructions, wherein the computing instructions, when executed by the one or more processors, are configured to cause the one or more processors to: interpret, with the intelligent dialogue model, an audible utterance of a user to determine one or more user-specific feature-value pairs, wherein the audible utterance comprises a natural language phrase corresponding to a feature-specific intent; and identify an item based on a matching score determined from the user-specific feature-value pairs compared with one or more item definitions defined in a database.

In another embodiment, the present invention is an intelligent natural language dialogue method for creating intelligent natural language dialogues for efficient retrieval of items in one or more large databases. The intelligent natural language dialogue method comprises: training, by one or more processors of a computing device, an intelligent dialogue model with one or more of feature-value pairs corresponding to one or more natural language phrases defining respective feature-specific intents; interpreting, with the intelligent dialogue model, an audible utterance of a user to determine one or more user-specific feature-value pairs, wherein the audible utterance comprises a natural language phrase corresponding to a feature-specific intent; and identifying, by the one or more processors, an item based on a matching score determined from the user-specific feature-value pairs compared with one or more item definitions defined in a database.

In yet another embodiment, the present invention is a tangible, non-transitory computer-readable medium storing instructions for creating intelligent natural language dialogues for efficient retrieval of items in one or more large databases. The instructions, when executed by one or more processors of a computing device, cause the one or more processors of the computing device to: train, by the one or more processors, an intelligent dialogue model with one or more of feature-value pairs corresponding to one or more natural language phrases defining respective feature-specific intents; interpret, with the intelligent dialogue model, an audible utterance of a user to determine one or more user-specific feature-value pairs, wherein the audible utterance comprises a natural language phrase corresponding to a feature-specific intent; and identify, by the one or more processors, an item based on a matching score determined from the user-specific feature-value pairs compared with one or more item definitions defined in a database.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram depicting an example intelligent natural language dialogue system configured to create intelligent natural language dialogues for efficient retrieval of items in one or more large databases, in accordance with various embodiments disclosed herein.

FIG. 2 illustrates an example mobile device communicatively coupled to and operable with the example intelligent natural language dialogue system of FIG. 1, in accordance with various embodiments disclosed herein.

FIG. 3 is a flow diagram illustrating an example intelligent natural language dialogue method for creating intelligent natural language dialogues for efficient retrieval of items in one or more large databases, in accordance with various embodiments disclosed herein.

FIG. 4 is a flow diagram illustrating an example intelligent dialogue model as used by intelligent natural language dialogue method of FIG. 3, in accordance with various embodiments disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

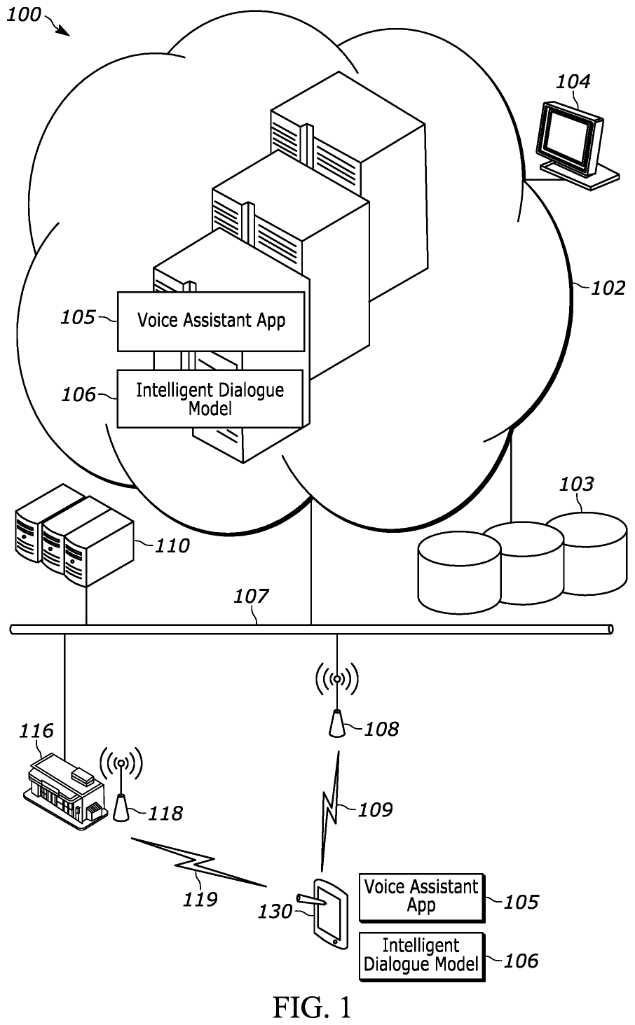

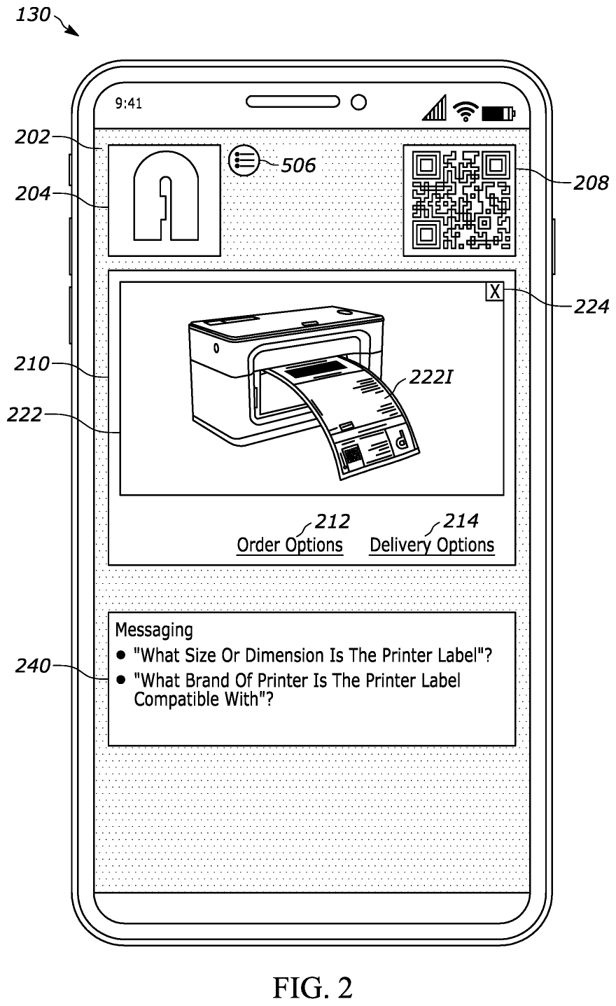

FIG. 1 is a system diagram depicting an example intelligent natural language dialogue system 100 configured to create intelligent natural language dialogues for efficient retrieval of items in one or more large databases, in accordance with various embodiments disclosed herein. In various embodiments, the intelligent natural language dialogue system 100 comprises a computing device comprising one or more processors. In some embodiments, the computing device may comprise a user device, such as a mobile device (e.g., mobile device 130) as described herein for FIG. 2.

Additionally, or alternatively, the computing device comprises one or more processor(s) of one or more server(s), e.g., server(s) 102. Server(s) 102 may include one or more servers and/or processors configured to transmit and receive data, information, user interfaces, or other such data as described in the various embodiments herein. In some embodiments, server(s) 102 may be a rules driven and/or data driven server, where server(s) 102 executes decisions and/or transmits data, information and/or user interfaces based on predetermined rules and/or data stored or determined from transactions or otherwise as described herein. Such data may be stored in related database(s) 103, which may be a local or remote database, or electronic storage facility, communicatively coupled to server(s) 102. Server(s) 102 may implement massive data or big data software or a framework (e.g., Apache Hadoop) to process, receive, transmit, and/or lookup data or information to and from database(s) 103 for efficient retrieval of items in one or more large databases based on natural language queries.

Server(s) 102 may comprise one or more servers (e.g., a server farm) configured to execute computer instructions to perform operations associated with the systems and methods as described herein, for example, for implementing the example operations represented by the block diagrams or flowcharts of the drawings accompanying this description. In various embodiments, server(s) 102 may be implemented as a remote cloud platform that implements Software as a Service (SaaS) or is otherwise configured as a platform as a service (PaaS) to generate and/or transmit the user interfaces, data, and information of vendors and/or vendor locations as described herein.

In some embodiments, for example, server(s) 102 may implement enterprise service software that may include, for example, Restful API services, message queuing service, and event services that may be provided by various platforms or specifications, such as the J2EE specification implemented by any one of the Oracle WebLogic Server platform, the JBoss platform, or the IBM Web Sphere platform, etc.

Server(s) 102 may include one or more processors, such as, for example, one or more microprocessors, controllers, and/or any suitable type of processor. Server(s) 102 may further include memory (e.g., volatile memory or non-volatile memory) accessible by the processor(s), for example, via a memory controller. For example, the processors(s) may interact with the memory of the server(s) 102 to obtain, for example, machine-readable instructions stored in the memory corresponding to, for example, the operations represented by the flowcharts of this disclosure. Additionally or alternatively, machine-readable instructions corresponding to the example operations of the block diagrams or flowcharts may be stored on one or more removable media (e.g., a compact disc, a digital versatile disc, removable flash memory, etc.), or over a remote connection, such as the Internet or a cloud-based connection, that may be coupled to server(s) 102 to provide access to the machine-readable instructions stored thereon.

Server(s) 102 may further include a network interface to enable communication with other machines via, for example, one or more computer networks, such as a local area network (LAN) or a wide area network (WAN), e.g., the Internet. The network interface of server(s) 102 may include any suitable type of communication interface(s) (e.g., wired and/or wireless interfaces) configured to operate in accordance with any suitable protocol(s), e.g., Ethernet for wired communications and/or IEEE 802.11 for wireless communications.

Server(s) 102 may include input/output (I/O) interfaces to enable receipt of user input and communication of output data to and from the user, which may include, for example, any number of voice, keyboards, mice, USB drives, optical drives, screens, touchscreens, etc. For example, server(s) 102 may allow administrative or local access via local computer 104.

In various embodiments herein, server(s) 102 is communicatively coupled, via a computer network 107, to a vendor platform 110 of a vendor. In the embodiment of FIG. 1, vendor platform 110 is remote to server(s) 102.

In various embodiments, server(s) 102 is configured to receive information or data of inventory, products, metadata, or other data or information regarding vendor and/or its inventory of products available at one or more physical vendor location(s) (e.g. physical vendor location 116) of the vendor. For example, information or data of inventory, products, metadata, or other data or information regarding vendor and/or its inventory of products may comprise a set of product data, including description(s), tags, SKUs, or other information useful for description a product, item, and/or service of the vendor. Vendor platform 110 may be implemented as one or more servers (including, e.g., one or more processors and memories) owned or controlled by the vendor for purposes of generating, updating, and/or otherwise managing user product inventory data and/or vendor data as may be used for generating, analyzing, interpreting, and/or otherwise processing and/or using intelligence dialogue models and/or audible utterances as described herein. Such product inventory and/or vendor related information or data may be stored in or otherwise transmitted from vendor platform 110. Additionally, or alternatively, product inventory and/or vendor related information or data may be received from physical vendor location 116 (e.g., from a centralized controller, server, or otherwise processor based computing device of physical vendor location 116). Such information may be transferred to server(s) 102 for analysis, training, interpretation, or otherwise as described herein

In the embodiment of FIG. 1, server(s) 102 is commutatively coupled to one or more mobile devices, e.g., mobile device 130. Mobile device 130 may be connected to server(s) 102 via a variety of communication standards, protocols, and networks. For example, mobile device 130 may be connected to server(s) 102 where mobile device 130 use wireless communication (119) to communicate with physical vendor location communication systems (118), which in turn communicate, via computer network 107, with server(s) 102. Such wireless communications (e.g., 119) may be implemented via wireless 802.11 (WiFi) and/or Bluetooth communication standards and/or protocols. Additionally, or alternatively, mobile device 130 may communicate with server(s) 102 via cellular or other mobile communication standards 109 (e.g., GSM, LTE, UMTS, etc.), for example, via base station 108 connected to computer network 107.

Mobile device 130 may include, but is not limited to a tablet, smart phone, or and/or such mobile device. Mobile device 130 may communicate via wireless communication (e.g., 119) and/or cellular communication (109), e.g., via computer network 107, with any of server(s) 102, vendor platform 110, physical vendor location 116 (e.g., via a processor computing device of physical vendor location 116).

As illustrated by FIG. 1, server(s) 102 may execute, implement, or stored (in memory) a voice assistant application (app) 105 and/or intelligent dialogue model 106. Additionally, or alternatively, mobile device 130 may execute, implement, or stored (in memory) a voice assistant application (app) 105 and/or intelligent dialogue model 106. Voice assistant app 105 comprises computing instructions that may be executed or implemented to interpret, with intelligent dialogue model 106, an audible utterance of a user to determine one or more user-specific feature-value pairs as described herein. An audible utterance may a natural language phrase corresponding to a feature-specific intent determined from the audible utterance. Voice assistant app 105 may also execute or implement computing instructions to identify an item based on a matching score determined from the user-specific feature-value pairs compared with one or more item definitions defined in a database (e.g., database(s) 103).

In some embodiments, portions of voice assistant app 105 and/or intelligent dialogue model 106 may be situated at server(s) 102 and/or mobile device 130. For example, voice assistant app may comprise client-server related application code or app code, where a first portion of voice assistant app 105 on mobile device 130 communicates with a second portion of voice assistant app 105 on server(s) 102.

The first portion and/or second portion of voice assistant app 105 may access or otherwise interact with intelligent dialogue model 106 (which itself may store or implemented on server(s) 102 and/or mobile device 130) in order to interpret an audible utterance of a user to determine one or more user-specific feature-value pairs and/or identify item(s) based on a matching score determined from the user-specific feature-value pairs compared with one or more item definitions defined in a database, as described herein.

In some embodiments, intelligent dialogue model 106 may be stored, be implemented as, or may otherwise comprise intelligent dialogue model 106 an android package (APK) file that maybe be deployed to and/or implemented on an ANDROID based mobile operation system (e.g., where mobile device 130 is an ANDROID based device). For example, in such embodiments, intelligent dialogue model 106 may be deployed from Google Dialogue where intelligent dialogue model 106 is trained or otherwise developed and/or generated via Google Dialogue cloud tool or platform. For example, the toolkit used to train or implement intelligent dialogue model 106 may comprise Google Dialogflow (GDF). The related APK could be created directly from GDF. There may also be supporting fulfillment code (e.g. voice assistant app 105) that accesses and uses the APK or otherwise intelligent dialogue model 106 as implemented on mobile device 130 and/or server(s) 102. It is to be understood, however, that other operating systems (e.g., iOS of APPLE), related platforms, cloud based tools, may be used instead.

FIG. 2 illustrates an example mobile device (e.g., mobile device 130) communicatively coupled to and operable with the example intelligent natural language dialogue system of FIG. 2, in accordance with various embodiments disclosed herein. FIG. 2 illustrates an example mobile device (e.g., mobile device 130) implementing an embodiment of a graphic user interface (a GUI 202), in accordance with various embodiments disclosed herein. In the example of FIG. 2, GUI 202 is executed on mobile device 500. GUI 202 may be implemented as part of, or together with, the computing instructions of voice assistant app 105. GUI 202 has been rendered on the display of mobile device 130, which in the embodiment of FIG. 2 is a smartphone mobile device.

As shown in the example of FIG. 1, GUI 202 includes a logo or trademark 204 of the vendor, and a QR code 208, which may pertain to the current product (e.g., product 2221) identified by the user's interaction with intelligent natural language dialogue system 100. GUI 202 further includes menu 206, which may be used to add user information, set settings, provide prompted information, or otherwise interact with the GUI 202 as described herein. For example, menu 206 may include options or submenus that allow a user to enter credit card, PayPal, and/or other payment information. Such information could be sent to a vendor (e.g., vendor platform 110 and/or physical vendor location 116) and/or server(s) 102 for purchase of a product (e.g., product 2221). Additionally, or alternatively, such information may be stored locally on mobile device 130 and/or remotely at any of vendor platform 110, physical vendor location 116 and/or universal server(s) 102.

In the embodiment, of FIG. 1, computing instructions, such as computing instructions of voice assistant app 105 are configured to, when executed by the one or more processors (e.g., of mobile device 130), cause the one or more processors to display a visual representation of an item (e.g., product label) on a GUI 202 of the computing device. For example, as shown, GUI 202 renders a product view 210 displaying one or more product windows. For example, product view 210 shows product window 222. Product window 222 depicts a product 2221 (i.e., a product label). The product label may be of a particular size, dimension, and/or may correspond to printing one or more types of printers.

In some embodiments, GUI 202 further includes order options 212 and/or delivery options 214. For example, order options 212 may be a selectable option that allows a user to register for notices or status updates.

Delivery options 214 may include one or more selectable options that allow a user to schedule delivery of one or more products, e.g., product 2221, to a user. For example, a vendor may partner with a third-party (e.g., Uber, Lyft, etc.), or employ its own personnel, to deliver products (e.g., 2221) to a user's home.

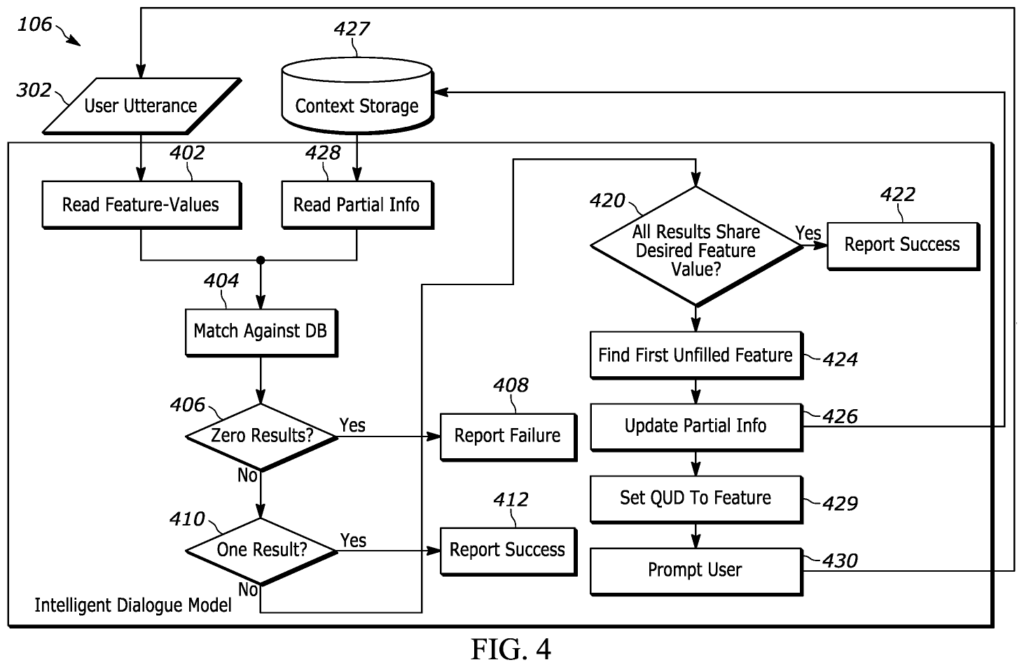

In some embodiments, GUI 202 includes messaging, which may displayed or rendered via messaging interface 240 and/or audibly output (via a speaker of mobile device 130). In particular, computing instructions, such as computing instructions of voice assistant app 105 are configured to, when executed by the one or more processors (e.g., of mobile device 130), cause the one or more processors to prompt the user (e.g., block 430 of FIG. 4) for an additional utterance, the prompt corresponding to additional feature-values needed to identify the item. Such messages may be displayed or rendered via messaging interface 240. Such messages may also be audible (output via a speaker of mobile device 130).

For example, in various embodiments, messaging interface 240 may display prompts to the user for additional information in order to identify an item (e.g., a printer label regarding product 2221). Such prompts may ask the user, e.g., “What size or dimension is the printer label?” and/or “What brand of printer is the printer label compatible with”? Other such prompts (whether displayed or audible) and for additional and/or different products are contemplated herein. More generally, such prompts are designed to allow the intelligent natural language dialogue system 100 to gather additional information from a user to more accurately identify an item as described herein.

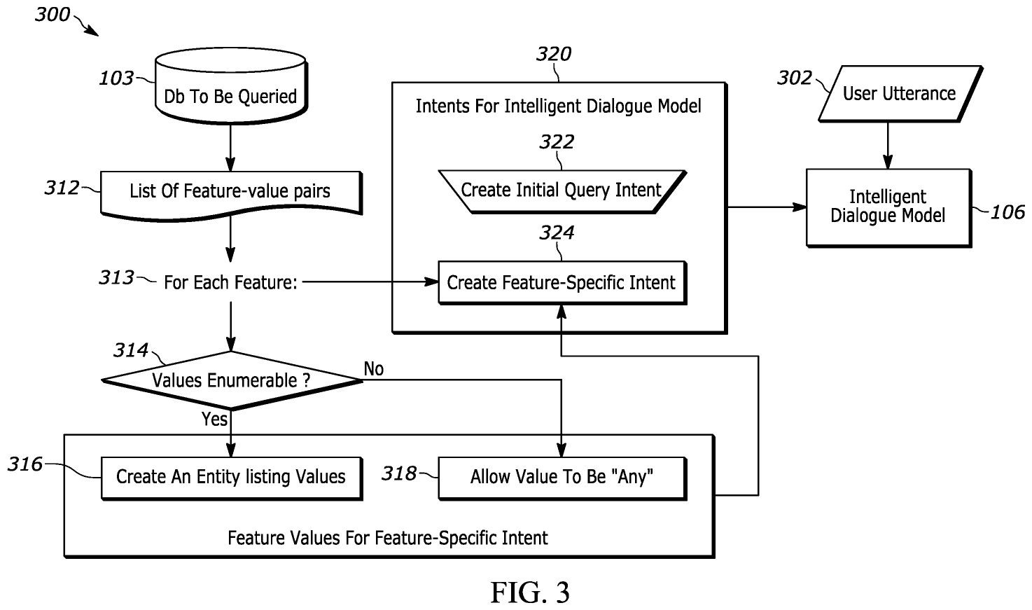

FIG. 3 is a flow diagram illustrating an example intelligent natural language dialogue method 300 for creating intelligent natural language dialogues for efficient retrieval of items in one or more large databases, in accordance with various embodiments disclosed herein. Method 300 depicts a flow chart representing an algorithm, representative of computing instructions, which may be implemented in one or more programming languages, e.g., JAVA, C, C++, Python, and/or the like. Method 300 may be implemented on one or more processor(s), such as one or more processor(s) of server(s) 102 and/or mobile device 130.

At block 302, method 300 comprises receiving an utterance of a user. For example, the utterance of the user may be received at a microphone of the mobile device 130. The utterance may be digitized, e.g., via a digital sampling, and provided to one or more processor(s), such as one or more processor(s) of server(s) 102 and/or mobile device 130, for processing and/or analytics by as described herein.

The user utterance is provided, e.g., by computing instructions of voice assistant app 105, to intelligent dialogue model 106, as described herein for FIGS. 1 and 4. Generally, generation of an intelligent dialogue model (e.g., intelligent dialogue model 106) comprises the generation of a query system (used to query the database) to allow for search query given a user utterance.

FIG. 3 illustrates data analysis and training intelligent dialogue model 106. For example, FIG. 3 comprises training, by one or more processors of a computing device (e.g., one or more processor(s) of server(s) 102), an intelligent dialogue model with one or more of feature-value pairs corresponding to one or more natural language phrases defining respective feature-specific intents. Generally, an “intent” defines what the user wants to do or accomplish, e.g., find a product in a store, e.g., physical vendor location 116) and/or look up a product (e.g., product 2221) to determine its size(s), e.g., width or dimension size. The intelligent natural language dialogue systems and methods herein analyze the user's intent (from an utterance) to determine, based on natural language processing, feature-value pairs for the purpose of identifying an item (e.g., product 2221) based on a matching score determined from the user-specific feature-value pairs compared with one or more item definitions defined in a database (e.g., database(s) 103).

At block 312, method 300 comprises querying, from a database (e.g., database 103) a list comprising one or more feature-value pairs. Feature value pairs comprise data values that correspond to real-world product features, and that may be linked or associated in data, e.g., such as via key-value pairs. For example, a printer label may be product having a width feature. In such embodiment a feature-value pair for the printer label may comprise a feature of “printer-label-width” with a value of “2.25 inches width.” Feature-value pairs may be added manually (e.g., via an operator of terminal 104) and/or may be added automatically to database 103 via user utterances or via batch data.

At block 312, for each feature in the feature-value pairs, method 300 comprises creating an initial query intent of, or for use by, the intelligent dialogue model 106.

At block 314, method 300 comprises an optional determination of determining whether the values of a feature-value intent are enumerable where one-or-more values may correspond to a given feature.

If so, at block 316, method 300 comprises generating a multi-value feature-value pair that comprises a data entity listing feature values (e.g., dimension and/or size) for feature-specific intent (e.g., a desire to find labels of a certain dimension and/or size). Such data entity or structure may be feature-value pairs that may comprise a multi-value feature-value pair comprising a feature paired to a plurality of enumerated values. If not, at block 318, the value may correspond to any feature for a given product and/or intent.

At block 320, intents are correlated, assigned, or otherwise associated with features to create feature-specific intents that may be used, or input, into intelligent dialogue model 106, as training data or as input for use of intelligent dialogue model 106 to provide an output.

In various embodiments, intelligent dialogue model 106 is trained with one or more of feature-value pairs (312) corresponding to one or more natural language phrases, e.g., determined from a user utterance (302), defining respective feature-specific intents. In some embodiments, Google Dialogflow (GDF) is used to create feature-specific intents where, e.g., a training phrase each possible value of a feature-value pair, as obtained from database(s) 103, is used to train intelligent dialogue model 106. In various embodiments, the training phases may be used to create respective feature-specific intents based on the one or more feature-value pairs. For example, the following training phrase (input and output) maybe used to create a feature-specific intent for a printer supplies, e.g., relating to a printer label (e.g., product 2221).

Intent Name: Domain+Sub-Domain+“Clarify”+<Feature Name>, where the contexts for input and output may be: Input: <domain>(_demo), <domain>_qud_<feature-name>, and output: <domain>(_demo) w/life-cycle 5, <domain>_qud_<feature-name> w/life-cycle 0.

In the above example, a feature-specific intent may be provided by providing a domain (e.g., “Printer”) and a sub-domain (e.g., “Supplies”), with a context “printer qud width.” The training phrases (utterances) may be any one or more of “one point five,” “three point zero inches,” two and a quarter inches, “one inch,” or the like, that correspond to natural language phrases that may be detected within the utterance (302) of the user. Such feature-specific intents may be used to train intelligent dialogue model 106 for matching a user's utterance to an item based on the features identified in the user's natural language query.

FIG. 4 is a flow diagram illustrating an example intelligent dialogue model (e.g., intelligent dialogue model 106) as used by intelligent natural language dialogue method of FIG. 3, in accordance with various embodiments disclosed herein.

At block 402, user utterance (302) is received. The utterance (302) causes voice assistant application (app) 105 to query or read feature-value pairs from database(s) 103 and analyze and/or match feature-value pairs. Voice assistant app 105 accesses intents of as determined during training of intelligent dialogue model 106 to interpret a user utterance (302) to turn it into feature-values. For example, at block 402, intelligent natural language dialogue method 300 comprises interpreting, with the intelligent dialogue model, an audible utterance of a user to determine one or more user-specific feature-value pairs, wherein the audible utterance comprises a natural language phrase corresponding to a feature-specific intent. Interpretation may comprise natural language (NPL) processing, e.g., NPL parsing or key-term matching. Such analysis or matching can occur in real-time or near real-time during and/or after the user is making the utterance.

At block 404, the determined feature-value pairs are matched against the feature-value pairs stored in the database (e.g., database(s) 103).

At block 406, intelligent natural language dialogue method 300 comprises identifying, by one or more processors (e.g., server(s) 102 and/or mobile device 130), an item (e.g., product 2221) based on a matching score determined from the user-specific feature-value pairs compared with one or more item definitions defined in a database (e.g., database(s) 103). In some embodiments, the matching score may define a probability that the audible utterance corresponds to the item as identified. In some embodiments, a higher match percentage may indicate a greater likelihood that utterance is for the identified product/item. In this way, matching feature-values may be determined and/or interpreted from a user utterance (302) to lookup or find feature-values in a database to determine a specific product or item.

In some embodiments, computing instructions (e.g., of voice assistant app 105) when executed by the one or more processors, may be further configured to cause the one or more processors to identify a second item based on a second matching score determined from the user-specific feature-value pairs compared with one or more item definitions defined in a database. The second matching score may be less significant to the matching score (e.g., 89% instead of 95% as for the first matching score).

At block 406, if no match is determined (zero results) then a failure (408), e.g., no hits, is reported (e.g., via GUI 202).

At block 410, if at least one result (one match) is determined, then success (412) is reported (e.g., via GUI 202).

At block 420 successful results are analyzed. If all results share a desired feature value (as expressed via the user's utterance and determined intent for a given feature), then success is reported (422).

However, if one or more features are undetermined or otherwise do not share a desired feature value, then, at block 424, then the computing instructions execute to find a first (or second, or further) unfilled feature (424). This includes updating partial information (426) needed to re-query the database to add the partial information for matching against the database, as described for block 402 and 404. The QUD (Question Under Discussion) to feature information is set (429). The user is the prompted (430) to provide an additional utterance (302) find the unfulfilled feature. The loop of FIG. 4 may be repeated as many times as necessary to meet all unfilled features (for all feature-value pairs for a given feature-specific intent) until success is reported 422.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may comprise one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An intelligent natural language dialogue system configured to create intelligent natural language dialogues for efficient retrieval of items in one or more large databases, the intelligent natural language dialogue system comprising:
a computing device comprising one or more processors;
an intelligent dialogue model accessible by the one or more processors, the intelligent dialogue model trained with one or more of feature-value pairs corresponding to one or more natural language phrases defining respective feature-specific intents; and
a voice assistant application (app) comprising computing instructions, wherein the computing instructions, when executed by the one or more processors, are configured to cause the one or more processors to:
interpret, with the intelligent dialogue model, an audible utterance of a user to determine one or more user-specific feature-value pairs, wherein the audible utterance comprises a natural language phrase corresponding to a feature-specific intent, and
identify an item based on a matching score determined from the user-specific feature-value pairs compared with one or more item definitions defined in a database.

2. The intelligent natural language dialogue system of claim 1, wherein the one or more feature-value pairs comprises a multi-value feature-value pair comprising a feature paired to a plurality of enumerated values.

3. The intelligent natural language dialogue system of claim 1, wherein matching score defines a probability that the audible utterance corresponds to the item as identified.

4. The intelligent natural language dialogue system of claim 1 further comprising creating the respective feature-specific intents based on the one or more feature-value pairs.

5. The intelligent natural language dialogue system of claim 1, wherein the computing instructions, when executed by the one or more processors, are further configured to cause the one or more processors to:
display a visual representation of the item on a graphic user interface of the computing device.

6. The intelligent natural language dialogue system of claim 1, wherein the computing instructions, when executed by the one or more processors, are further configured to cause the one or more processors to:
identify a second item based on a second matching score determined from the user-specific feature-value pairs compared with one or more item definitions defined in a database, the second matching score being less significant to the matching score.

7. The intelligent natural language dialogue system of claim 1, wherein the computing instructions, when executed by the one or more processors, are further configured to cause the one or more processors to:
prompt the user for an additional utterance, the prompt corresponding to additional feature-values needed to identify the item.

8. An intelligent natural language dialogue method for creating intelligent natural language dialogues for efficient retrieval of items in one or more large databases, the intelligent natural language dialogue method comprising:
training, by one or more processors of a computing device, an intelligent dialogue model with one or more of feature-value pairs corresponding to one or more natural language phrases defining respective feature-specific intents;
interpreting, with the intelligent dialogue model, an audible utterance of a user to determine one or more user-specific feature-value pairs, wherein the audible utterance comprises a natural language phrase corresponding to a feature-specific intent; and
identifying, by the one or more processors, an item based on a matching score determined from the user-specific feature-value pairs compared with one or more item definitions defined in a database.

9. The intelligent natural language dialogue system of claim 8, wherein the one or more feature-value pairs comprises a multi-value feature-value pair comprising a feature paired to a plurality of enumerated values.

10. The intelligent natural language dialogue system of claim 8, wherein matching score defines a probability that the audible utterance corresponds to the item as identified.

11. The intelligent natural language dialogue system of claim 8 further comprising creating the respective feature-specific intents based on the one or more feature-value pairs.

12. The intelligent natural language dialogue system of claim 8, wherein the computing instructions, when executed by the one or more processors, are further configured to cause the one or more processors to:
display a visual representation of the item on a graphic user interface of the computing device.

13. The intelligent natural language dialogue system of claim 8, wherein the computing instructions, when executed by the one or more processors, are further configured to cause the one or more processors to:
identify a second item based on a second matching score determined from the user-specific feature-value pairs compared with one or more item definitions defined in a database, the second matching score being less significant to the matching score.

14. The intelligent natural language dialogue system of claim 8, wherein the computing instructions, when executed by the one or more processors, are further configured to cause the one or more processors to:
prompt the user for an additional utterance, the prompt corresponding to additional feature-values needed to identify the item.

15. A tangible, non-transitory computer-readable medium storing instructions for creating intelligent natural language dialogues for efficient retrieval of items in one or more large databases, that when executed by one or more processors of a computing device cause the one or more processors of the computing device to:
train, by the one or more processors, an intelligent dialogue model with one or more of feature-value pairs corresponding to one or more natural language phrases defining respective feature-specific intents;
interpret, with the intelligent dialogue model, an audible utterance of a user to determine one or more user-specific feature-value pairs, wherein the audible utterance comprises a natural language phrase corresponding to a feature-specific intent; and
identify, by the one or more processors, an item based on a matching score determined from the user-specific feature-value pairs compared with one or more item definitions defined in a database.
